(19) United States
(12) Patent Application Publication
(10) Pub. No.: US 2006/0146483 A1
(43) Pub. Date: Jul. 6, 2006

(54) Battery door cover bottle opener

(75) Inventors: Joseph Patino, Pembroke Pines, FL (US); Jon P. Reus, Plantation, FL (US); Roberto Rodriguez, Weston, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/026,729

(22) Filed: Dec. 30, 2004

(51) Int. Cl. H02B 1/00

(52) U.S. Cl. 361/600

(57) ABSTRACT

An electronic device (10) such as a mobile phone, a cellular phone, a two-way radio, a laptop computer, a portable stereo receiver, a portable television, or any combination thereof can include a cover such as a battery door cover (14) having a predetermined thickness and an aperture (16) within the battery door cover serving as an audio port for the electronic device and further constructed to serve as a bottle cap opener. The aperture can be for a high audio port (11) on a speaker phone for example. The aperture can be formed substantially towards an end portion of the battery door cover. The battery door cover can also be made of a rigid material such as plastic, metal or carbon fiber composite and can further include a sharp edge (17) to serve as a cutting instrument. Optionally, the battery door can further include a retractable or removable blade (19).

### FIELD OF THE INVENTION

This invention relates generally to battery door covers, and more particularly to dual function battery door covers that serve additional functions.

### BACKGROUND OF THE INVENTION

Cellular phones are ubiquitous as mobile handheld tools that tend to include additional functionality and entertainment value as time progresses. The additional functionality generally involves electronic features such as games and productivity tools such as calendars, spreadsheets, and email. Most people tend to view handheld phones as electronic tools and overlook the hardware or mechanical aspects that a mobile phone can conveniently provide in numerous settings.

Bottle openers are generally not associated with mobile phones and usually come as a separate tool one needs to remember to carry. At open air events such as concerts and car races, bottled refreshments are typically served or brought with spectators in coolers or other containers. Many spectators bring along their cellular phones to such events, but such phones fail to also serve as bottle openers.

### SUMMARY OF THE INVENTION

Embodiments in accordance with the present invention can provide additional mechanical functionality to an electronic product by forming and using an aperture in a battery door cover for a bottle cap opening among other functions.

In a first embodiment of the present invention, an electronic device such as mobile phone, a cellular phone, an MP3 player, a two-way radio, a personal digital assistant, a laptop computer, a portable stereo receiver, a portable television, or any combination thereof can include a cover such as a battery door cover having a predetermined thickness and an aperture within the battery door cover serving as an audio port for the electronic device and further constructed to serve as a bottle cap opener. The aperture can be for an audio port on a speaker phone for example. The aperture can be formed substantially towards an end portion of the battery door cover. The battery door cover can also be made of a rigid material such as plastic, metal or carbon fiber composite and can further include an edge to serve as a cutting instrument. Optionally, the battery door can further include a retractable blade.

In a second embodiment of the present invention, a communication device having an audio port can include a housing having a battery compartment, a battery door cover for covering the battery compartment, and an aperture in the battery door cover providing an audio passage for the audio port and further constructed to serve as a bottle cap opener.

In a third embodiment of the present invention, a mobile phone device having a speaker phone port can include a housing having a battery compartment, a battery door cover for covering the battery compartment, and an aperture in the battery door cover providing high audio passage for the high audio port and further constructed to serve as a bottle cap opener.

Other embodiments, when configured in accordance with the inventive arrangements disclosed herein, can include other various arrangements performing the same or similar functions as claimed and described herein.

### BRIEF DESCRIPTION OF THE DRAWINGS

FIG. 1 is rear perspective view of an electronic product having a battery door cover and an audio port in accordance with an embodiment of the present invention.

FIG. 2 is another illustration of the electronic product of FIG. 1 with the battery door cover removed in accordance with the an embodiment of the present invention.

FIG. 3 is a front view of the battery door cover having an aperture therein used as an audio port and bottle opener in accordance with an embodiment of the present invention.

FIG. 4 is an illustration of a bottle having a bottle cap that can be opened with the battery door cover of FIG. 3 serving as a bottle opener in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

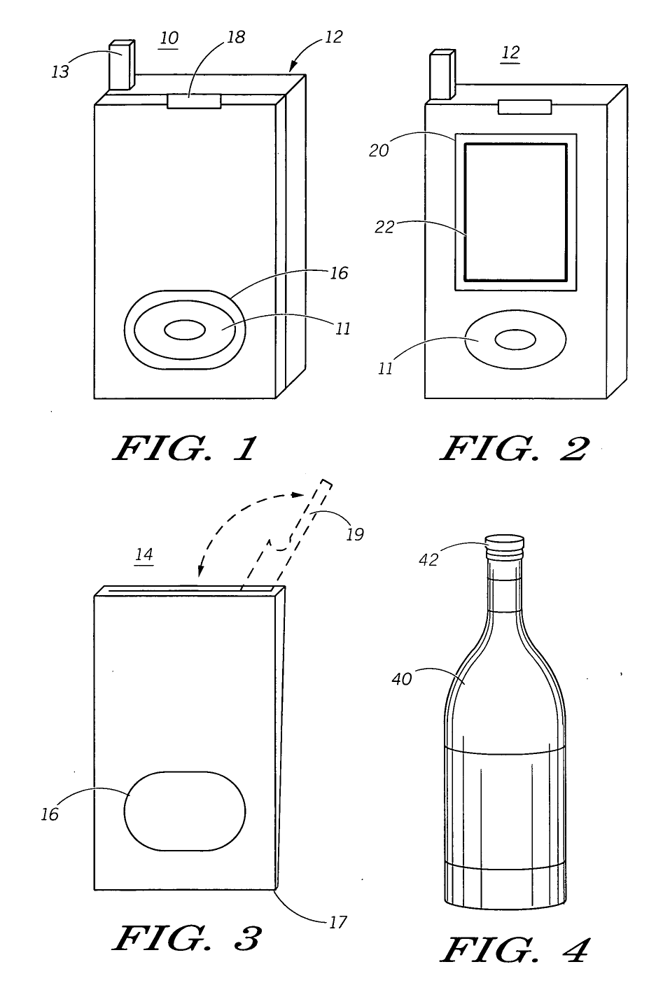

Referring to FIG. 1, an electronic device 10 such as a mobile phone, a cellular phone, an MP3 player, a two-way radio, a personal digital assistant, a laptop computer, a portable stereo receiver, a portable television, or any combination thereof can include a main housing portion 12 including an antenna 13, a door latch 18, and an audio output device 11 such as a speaker. The electronic device 10 can further include a face plate or battery door cover 14 having a predetermined thickness and an aperture 16 within the battery door cover 14 serving as an audio port for the audio output device 11 of the electronic device 10 and further constructed to serve as a bottle cap opener. The battery door cover 14 can be selectively detachable from the main housing portion 12 using the door latch 18. Once the battery door cover 14 is removed as shown in FIG. 2, access can be provided to a battery compartment 20 and any battery 22 (or batteries) therein. Note, the cover 14 is not necessarily limited to the battery door cover shown, but can also comprise other types of covers such as faceplates and other types of compartment door covers.

Referring to FIG. 3, the battery door cover 14 is shown separately. The aperture 16 can be for a high audio port on a speaker phone for example. The aperture can be formed substantially towards an end portion of the battery door cover such as the bottom to provide sufficient leverage when opening a bottle cap 42 on a bottle 40 as illustrated in FIG. 4. The battery door cover 14 can also be made of a rigid material such as plastic, metal or carbon fiber composite and can further include a relatively sharp edge 17 that can serve as a cutting instrument if sufficient pressure is applied. By rigid, it is meant that the battery door cover material can be hard and flexible enough to avoid permanent deformation (cracking, bending, kinks) when applying pressure or using the cover as a lever when removing a bottle cap. The sharp edge 17 can be designed to enable the cutting of limes or lemons for example when sufficient pressure is applied, yet still be dull enough to avoid minor cuts to skin when used as an ordinary battery door cover in the recommended course of use. Optionally, the battery door cover 14 can further include a retractable or removable blade 19 that can also serve to cut citrus to enable flavor enhancements to any refreshments carried by such bottle 40. The optional blade, if configured appropriately, can also serve as a can opener or a screwdriver. Of course, such an optional retractable blade can also be used for other cutting purposes, but users should avoid carrying or remove such optional items if they will cause security issues when traveling or attending public events.

As noted above, the electronic device 10 can be a communication device having a high audio port 11 and further having a battery door cover 14 with an aperture 16 providing high audio passage for the high audio port 11 and further constructed to serve as a bottle opener. In this regard, the communication device can be a mobile phone device having a speaker phone port for the high audio port 11.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. An electronic device, comprising:
a cover having a predetermined thickness; and
an aperture within the cover serving as an audio port for the electronic device and further constructed to serve as a bottle cap opener.

2. The electronic device of claim 1, wherein the electronic device is selected among the group comprising a cellular phone, an MP3 player, a two-way radio, a personal digital assistant, a laptop computer, a portable stereo receiver, a portable television, and any combination thereof.

3. The electronic device of claim 1, wherein the cover is a battery door cover or a faceplate made of a rigid material.

4. The electronic device of claim 1, wherein the cover further comprises an edge to serve as a cutting instrument.

5. The electronic device of claim 1, wherein the cover further comprises a retractable blade.

6. The electronic device of claim 1, wherein the aperture is for an audio port on a speaker phone.

7. The electronic device of claim 1, wherein the aperture is formed substantially towards an end portion of the cover.

8. A communication device having an audio port, comprising:
a housing;
a cover for covering at least a portion of the housing; and
an aperture in the cover proving audio passage for the audio port and further constructed to serve as a bottle cap opener.

9. The communication device of claim 8, wherein the communication device is selected among the group comprising a cellular phone, an MP3 player, a two-way radio, a personal digital assistant, a laptop computer, a portable stereo receiver, a portable television, and any combination thereof.

10. The communication device of claim 8, wherein the cover is a battery door cover made of a material selected among the group comprising rigid plastic, metal, and composite carbon fiber.

11. The communication device of claim 8, wherein the cover further comprises an edge to serve as a cutting instrument.

12. The communication device of claim 8, wherein the cover further comprises a retractable blade.

13. The communication device of claim 8, wherein the aperture is for an audio port on a speaker phone.

14. A mobile phone device having a speaker phone port, comprising:
a housing having a battery compartment;
a battery door cover for covering the battery compartment; and
an aperture in the battery door cover providing high audio passage for the high audio port and further constructed to serve as a bottle cap opener.

15. The mobile phone device of claim 14, wherein the mobile phone device is selected among the group comprising a cellular phone, a two-way radio, a smart-phone and any combination thereof.

16. The mobile phone device of claim 14, wherein the battery door cover is made of a rigid material.

17. The mobile phone device of claim 14, wherein the battery door cover further comprises an edge to serve as a cutting instrument.

18. The mobile phone device of claim 14, wherein the battery door cover further comprises a retractable blade.

19. The mobile phone device of claim 14, wherein the aperture is formed substantially towards an end portion of the battery door cover.

20. The mobile phone device of claim 14, wherein the battery door cover further comprises a retractable blade that serves among the functions of a cutting device, a can opening device and a screwdriver.
